(19) United States
(12) Patent Application Publication
(10) Pub. No.: US 2011/0256914 A1
(43) Pub. Date: Oct. 20, 2011

(54) Interactive games with prediction and plan with assisted learning method

(76) Inventor: Ned M. Ahdoot, Rancho Palos Verdes, CA (US)

(21) Appl. No.: 12/798,335

(22) Filed: Apr. 2, 2010

Related U.S. Application Data
(63) Continuation-in-part of application No. 11/189,176, filed on Jul. 25, 2005, now abandoned.

(51) Int. Cl. A63F 9/24; A63F 13/00

(52) U.S. Cl. 463/8; 463/30

(57) ABSTRACT

A method for engaging a player or a pair of players in a motion related game including the steps of attaching plural geometrical colored elements onto selected portions of the player(s) garments and processing a video stream of each of the players to separately identify the positions, velocities an accelerations of the colored elements. The method further comprises generation of a combatant competitor image and moving the image in a manor to overcome the player. In a further approach, two players are recorded and their video images are presented one screens frontal to the other of the players. The same colored elements are used to enable controller calculations of fighting proficiency of the players and enable assisted learning.

### FIELD OF THE SUBJECT MATTER

This invention relates generally to games of interactive play between two or more entities including individuals and controller simulated opponents, i.e., the invention may be used by two individuals, an individual and a simulation, and even between two simulations, as for demonstration purposes, and more particularly to a controller controlled interactive to movement and contact simulation game in which a player mutually interacts with a controller generated image that responds to the player's movement in real-time.

### DESCRIPTION OF RELATED ART

The following art defines the present state of this field:

Invention and use of controller generated, interactive apparatus are known to the public, in that such apparatus are currently employed for a wide variety of uses, including interactive games, exercise equipment, and astronaut training.
U.S. Pat. No. 7,445,551 issued Nov. 8, 2008
U.S. Pat. No. 7,292,151 issued Nov. 6, 2007
U.S. Pat. No. 7,009,613 issued Mar. 7, 2006
U.S. Pat. No. 7,073,090 issued Jul. 4, 2006
U.S. Pat. No. 6,767,286 issued Jul. 27, 2004
U.S. Pat. No. 6,431,286 issued Aug. 13, 2002
U.S. Pat. No. 6,435,880 issued Aug. 20, 2002
U.S. Pat. No. 6,462,729 issued Oct. 8, 2002
U.S. Pat. No. 6,468,157 issued Oct. 22, 2002
U.S. Pat. No. 6,493,277 issued Dec. 10, 2002
U.S. Pat. No. 6,500,008 issued Dec. 31, 2002
U.S. Pat. No. 6,545,661 issued Apr. 8, 2003
U.S. Pat. No. 6,514,142 issued Feb. 4, 2003
U.S. Pat. No. 6,512,522 issued Jan. 28, 2003
U.S. Pat. No. 6,572,478 issued Jun. 3, 2003
U.S. Pat. No. 6,679,776 issued Jun. 20, 2004
U.S. Pat. No. 6,676,566 issued Apr. 27, 2004
U.S. Pat. No. 6,917,371 issued Jul. 12, 2005

Ahdoot, U.S. Pat. No. 5,913,727 discloses an interactive contact and simulation game apparatus in which a player and a three dimensional controller generated image interact in simulated physical contact. Alternately two players may interact through the apparatus of the invention. The game apparatus includes a controllerized control means generating a simulated image or images of the players, and displaying the images on a large display. A plurality of position sensing and impact generating means are secured to various locations on each of the player's bodies. The position sensing means relay information to the control means indicating the exact position of the player. This is accomplished by the display means generating a moving light signal, invisible to the player, but detected by the position sensing means and relayed to the control means. The control means then responds in real time to the player's position and movements by moving the image in a combat strategy. When simulated contact between the image and the player is determined by the control means, the impact generating means positioned at the point of contact is activated to apply pressure to the player, thus simulating contact. With two players, each players sees his opponent as a simulated image on his display device.

### SUMMARY

The present invention teaches certain benefits in construction and use which give rise to the objectives described below.

A best mode embodiment of the present invention provides a method for engaging a player or a pair of players in a motion related game including the steps of attaching plural colored elements onto selected portions of the player(s); processing a video stream from a digital camera to separately identify the positions, velocities an accelerations of the several colored elements in time; providing a data stream of the video to a data Controller; calculating the distance between the player and the camera as a function of time; predicting the motions of the players and providing anticipatory motions of a virtual image in compensation thereof.

A primary objective of the present invention is to provide an apparatus and method of use of such apparatus that yields advantages not taught by the prior art.

Another objective of the invention is to provide a game for simulated combat between two individuals.

A further objective of the invention is to provide a game for simulated combat between an individual and a simulated second player of the game.

A further objective of the invention is to provide a game for simulated combat between an to individual carrying a sport instrument in hand and a simulated offense and defense players of the game.

A still further objective of the invention is to provide the virtual image to anticipate and predict the movement of the real player and to change the virtual image accordingly.

A still further objective of the invention is to provide an assisted learning for the system be more precise and refined providing more accurate predictions and plans for the player and the image offense and defense.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIG. 1 is a perspective view showing a method of the instant innovation providing video capture of the motions of a player and of projection of a competitor's image onto a screen;

FIG. 2 is a perspective view thereof showing one embodiment of the invention with a player at left and a simulated player's image at right;

FIG. 3 is a perspective view thereof showing a first and a second players in separate locations with video images of each projected onto a screen at the other player's location;

FIG. 5 is the block diagram of Event Detection and Prediction Controller;

FIG. 6 is the block diagram of Event Follower Controller Offense;

FIG. 7 is the block diagram of Event Follower Controller Defense;

FIGS. 8 and 9 are the description for the offense or defense method of hit evaluation and scoring;

FIGS. 10 and 10A are the block diagram for mass memory addressing hardware to allow assisted learning;

FIG. 11 is the flow chart for the Feedback Controller Activity.

### DETAILED DESCRIPTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the appended claims.

In the present apparatus and method, one or two players take part in a game involving physical movements. Such games may comprise simulated combat, games of chance, competition, cooperative engagement, and similar subjects. However, the present invention is ideal for use in games of hand-to-hand combat such as karate, aikido, kick-boxing and American style boxing where the players have contact but are not physically intertwined as they are in wrestling, Judo and similar sports. In this disclosure a combat game is described, but such is not meant to limit the range of possible uses of the present invention. In one embodiment of the instant combat game, a player 5 engages in simulated combat with an image 5′ projected onto a screen 10 placed in front of the player 5. In this embodiment, the image 5′ is controller generated using the same technology as found in game arcades. In an alternate embodiment, two players 5 stand in front of two separate screens 10 and engage in mutual simulated combat against recorded and projected images 5′ of each other. This avoids physical face-to-face combat where one of the players might receive injury. In this second approach, the images projected onto the screens 10 are not controller generated.

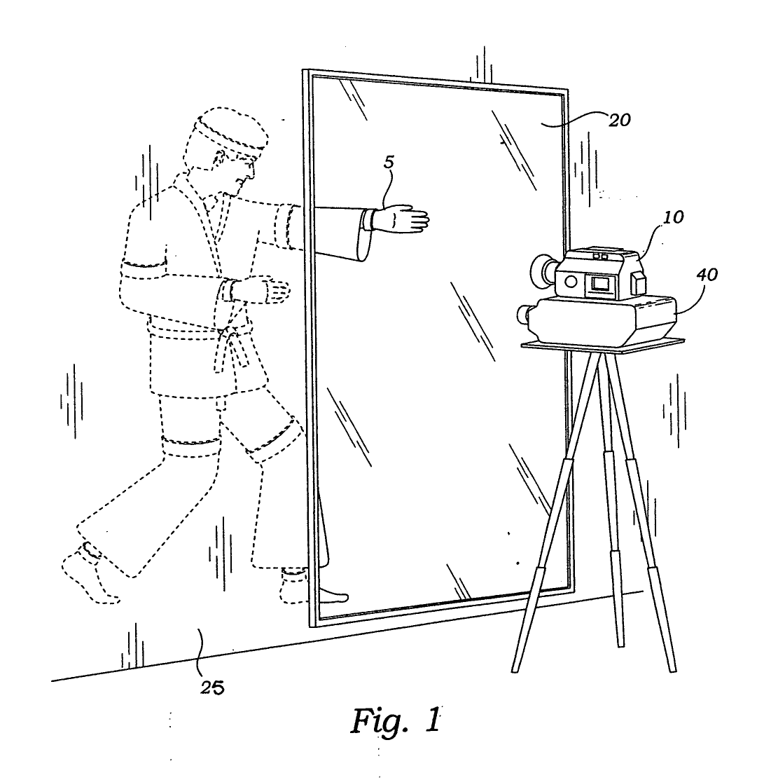

In the first approach, a player 5 is positioned in front of a rear projection screen 10. One or more video cameras 20, referred to here as a camera 20, is positioned behind the screen 10. The camera 20 is able to view the player 5 through the screen 10 and record the player's movements dynamically. If the screen 10 is not transparent enough for this to be done, the camera 20 is mounted on the front of the screen 10, or is mounted on or at the rear of the screen 10 viewing the player 5 through a small hole in the screen 10. The screen 10 may be supported by a screen stand (not shown) or it may be mounted on a wall 25 as shown. The screen 10 may also be mounted in the wall 25 with video equipment located on the side of the wall opposite the player 5 as shown in FIG. 1.

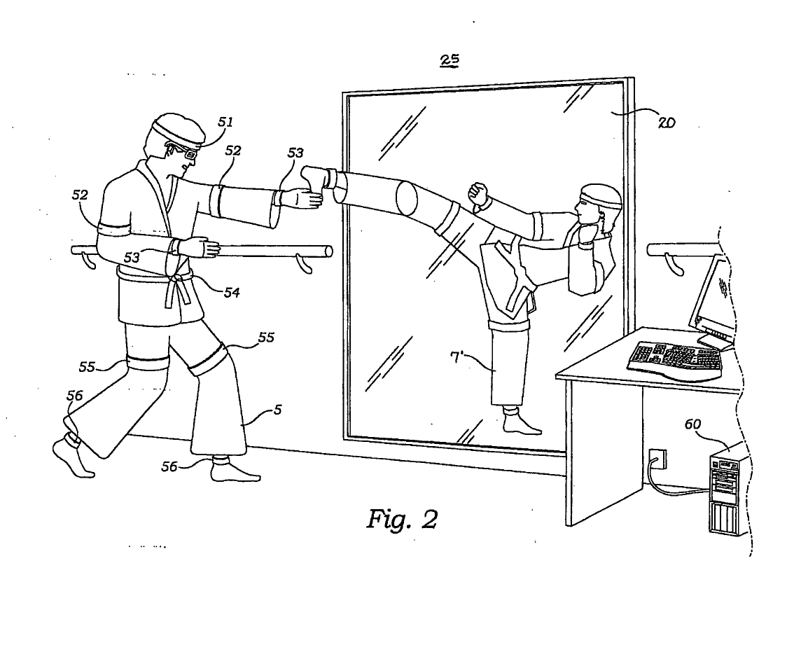

A video projector 30 projects a simulated image 5′ of a competitor combatant from the rear onto the screen 10 and this image 5′ is visible to the player 5 as shown in FIG. 2. In the approach where the camera 20 is located behind the screen 10, in order for the camera 20 to not record the projected image 5, both the camera 20 and the projector 30 operate at identical rates (frames per second) but are set for recording and projecting respectively for only one-half of each frame, and are interlaced so that recording occurs only when the projector 30 is in an off state, and projecting occurs only when the camera 20 is in an off state. The net result is that the player 5, positioned at the front of the screen 10, sees the projected image while the camera 20 sees the player 5 and not the projected image.

The screen 10 may be a two-way mirror with visibility of objects in front of the screen 10 very clear from the rear of the screen 20, and with visibility through the screen 10 from the front not possible, yet visibility of images projected onto the back of the screen 10 highly visible from in front.

In both of the above described approaches, the player 5 wears colored bands as best seen in FIG. 2. Preferably, the player 5 has a band 51 secured at his forehead, above each elbow 52, on each wrist 53, around the waist 54, above each knee 55 and on each ankle 56. Each of these 10 bands is a different color. Further bands may be placed in additional locations on the player, but the 10 bands shown in FIG. 2 as described, are able to achieve the objectives of the instant innovation as will be shown. In the instant method, the image 5′ of the player 5, as recorded by camera 20 is converted into a digital electronic signal. This signal is split into 10 identical signals and each of these 10 signals is filtered for only the color component related to one of the 10 bands 51-56. Each of the filtered signals contains two pieces of information: the location on the plane of the recording device of its related colored band as determined by which pixels are disposed to the band, and the distance from the recording device to the band as determined by the total number of pixels disposed to the band. This information, from all ten bands is processed by a controller 60 to form a composite image 5′ of the player 5.

### Example 1

The player 5 stands facing the screen 10 with feet a comfortable distance apart, legs straight, to and arms hanging at the player's sides. Each of the ten colored bands 51-56 are visible to the camera 20 and with a simple set of anatomical rules, the controller 60 is able to compose a mathematical model of the player's form that accurately represents the player's physical position and anatomical orientation at that moment. When a band moves, its image on the—recording plane moves accordingly so that the controller 60 is able to calculate the motion trajectory of the band. When the number of pixels related to a particular band diminishes or grows, the controller 60 is able to calculate the band's trajectory in 3-space. When a band disappears, the controller 60 calculation takes into account the corresponding portion of the human anatomy, has moved so as to be hidden behind another portion of the anatomy of the player 5. This example is represented in FIG. 2.

The controller 60 produces a digital image 5′ representing a competitor combatant and projects this image 5′ onto the screen 10 initially in a starting position with body erect, feet spread apart and arms at sides. As the player 5 moves to attack the competitor image 5′, the controller 60 calculates the trajectory of motion of the attacking element, i.e., hand, arm, leg, etc., of the player 5 and moves the image 5′ to defensive postures or to counter attack. The controller 60 is able to calculate if the player 5 has moved successfully to overcome defensive postures or counter attacks of the image 5′ so as to award points to the player 5′.

### Example 2

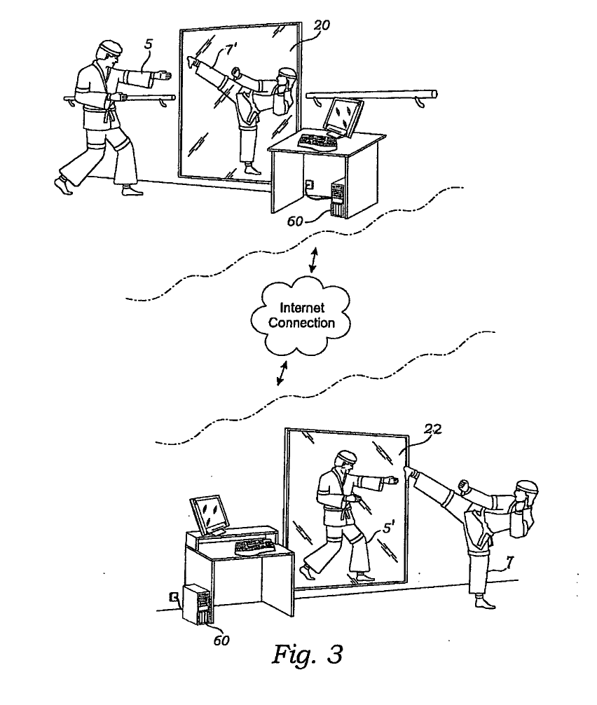

Two players 5 stand facing their respective screens 10, each with feet a comfortable distance apart, legs straight, and arms hanging at their sides. Each of the ten colored bands 51-56 on each of the players 5 are visible to their respective cameras 20 so that the controller 60 is able to compose mathematical models of each of the players 5 in a mathematical 3-space that accurately represents each of the player's physical position and anatomical orientation at that moment relative to the other of the player 5. The vertical plane represented by the screen 10 of one player 5 represents a vertical bisector of the other player 5. Therefore, when one player 5 moves a fist, elbow, knee or foot toward his screen 10, the controller 60 calculates that motion as projecting outwardly toward the other player 5 from the other player's screen 10. In this manner the controller 60 calculates contacts between players 5 in offensive and defensive moves. As in real face-to-face combat, the players 5 initially and nominally stand slightly more than an arm's length away from their screen, i.e., mathematically from their opponent. Points are awarded to each of the players for successful offensive and defensive moves. The images are preferably projected with three-dimensional realism by use of the well known horizontal and vertical polarization of dual simultaneous projections with slight image separation as is well known, and with the players 5 wearing horizontally and vertically polarized lenses so as to see a combined image providing the illusion of depth. In this manner, each of the players 5 sees the illusion of the opponent players image projecting toward him from the screen 10. This example is represented in FIG. 3.

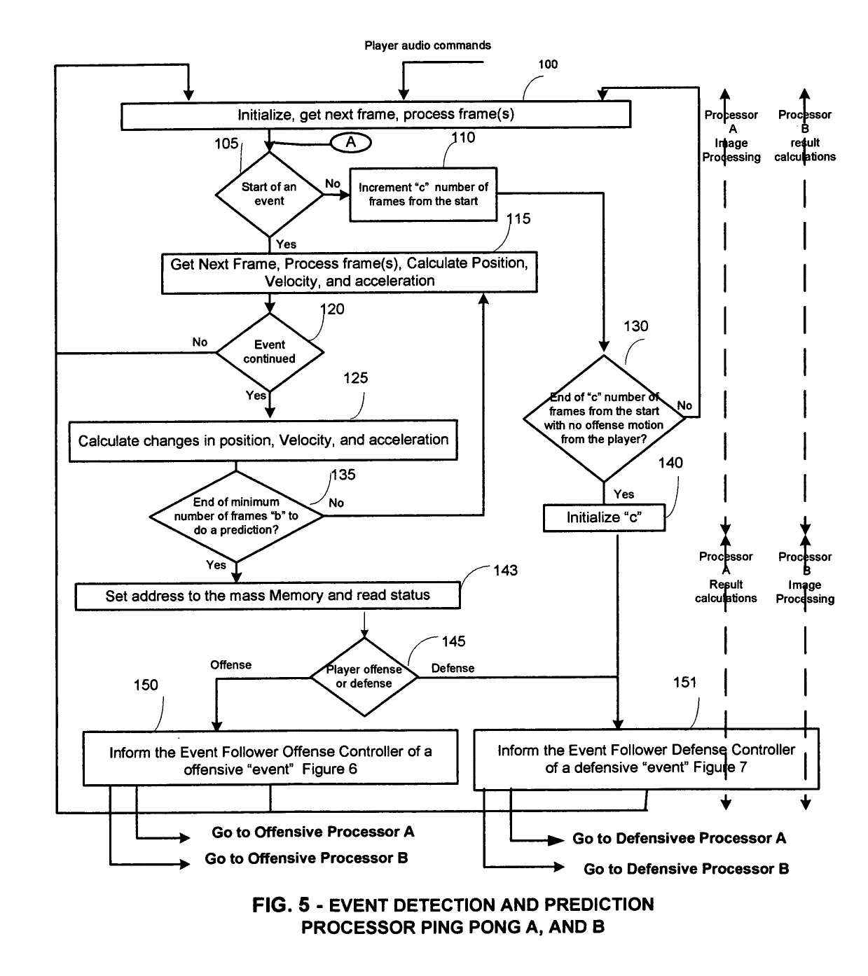

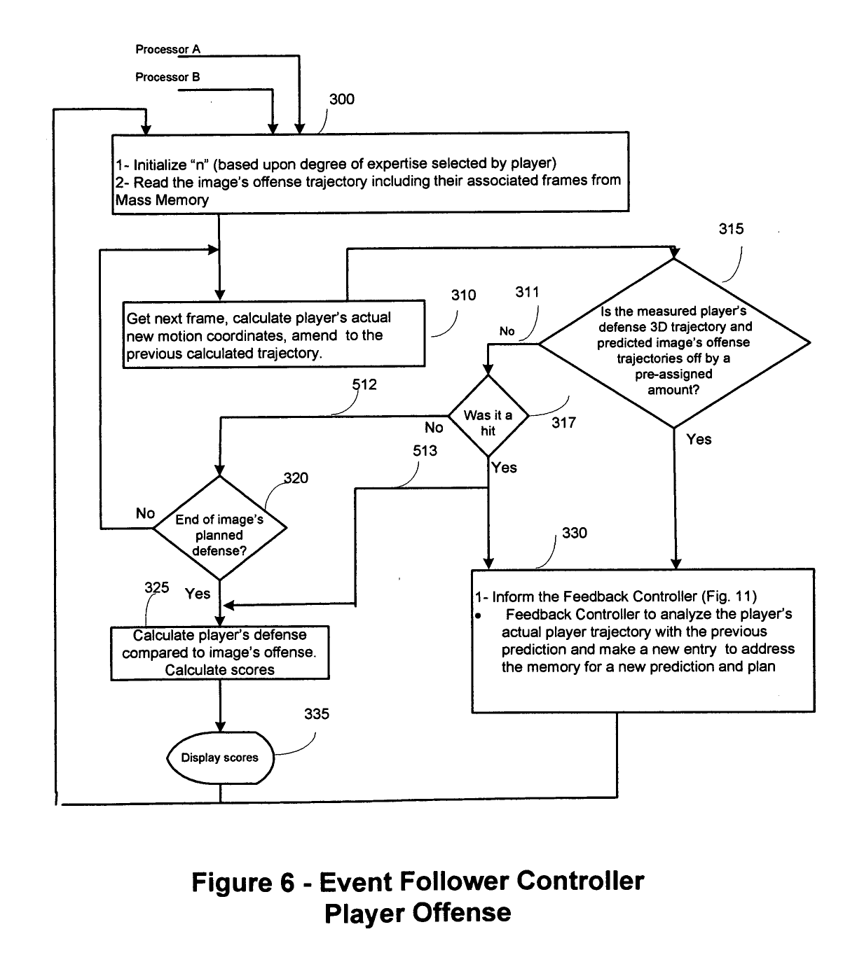

The present disclosure teaches an improved video frame processing method that enables the combative motions between two distant players 5 to be calculated and compared with respect to each other. This method is described as follows and is as shown in FIGS. 4-6. Once the game is initiated, a stream of frames from the video recorder 30 is processed. When motion is determined by a change in the position of any of the color elements 51-56 being recorded, position, velocity, as the differential of the position, and acceleration, as the second differential of the position of each of the ten color elements of the player 5, as discriminated by the signal filtering process described above, are calculated. Enablement of prediction is determined by evaluating the number of frames comprising a particular motion with a minimum number of frames set point. The calculations continue until the number of frames is at least equal to the set point. Depending on whether the motion is defensive, i.e., lagging the opponents movement, or offensive, i.e., independent of the opponent's movement, in any of the colored elements, the image is modified so as to defend against an offensive move by the player 5 or to initiate a new offensive move from an inventory of such moves. The final logical loops of this program are shown in FIGS. 5 and 6 and comprise the determination of incoming offense commands, calculation of the player's new coordinates, determination if the defense or offence is complete, and calculating the player's offensive positions as compared to the image defense moves and vice-versa, and determining a score for the player 5 in accordance with a stored table of score related motion and counter motion comparisons. For each of the motion and counter motion determinations for both offensive and defensive motions of players, a score is created and projected onto the to screen.

The above explained combat game of playing real time interactive motion related hand-to-hand combat involves a player wearing a 3D glasses and 3D colored geometric shape on his moving bodily parts such as head, hands and feet to get engaged with an image of a competitor player. An apparatus of hardware and software controller providing direct access to a mass memory system analyzes frames of the incoming video signals and then upon the detection of an offence or defense of the player, provides a prediction and a plan to fit a counter action by the image, The controller in addition to a generated 3D character, it also provides the appropriate displaying arena for player. The apparatus comprising the steps of the following summarized steps:
a) initialize the “n” (as will be discussed in the following paragraph) to the initial settings of the player, such as weight, height, style of play and degree of expertise.
b) The apparatus captures the received video frames from the player and identifies portions of the player with individual different three dimensional geometric colored elements.
c) Receiving the player's motion in visible light and IR as a video image and filtering the image into separate signals according to the colored 3D colored elements.
d) Determining positions in 3-space of the portions of the player on each video frame of the recording, thus calculating changes in 3-d position from one frame to another frame.
e) Positional changes from a frame to frame, in conjunction with the associated frame timing (period between frames) provides calculation of velocity, and accelerations.
f) Initial trajectory of a motion, including location, velocity and acceleration are established for a typical player motion within a period of time (“b” number of frames).
g) Identifying each player's early moves that is consistent within a period of time; “b” number of frames that is set during the initialization, to represent an early offense, defense, or no motion. This early detections of player's motions is similar to a boxer, predicting motions of the other player to plan a next course of offense or defense motion that is appropriate for the game played such as a strike, or a dodge. These early detections are hereafter called an “event” that will be further be explained in the following paragraphs.
h) Each event is further associated with a continuation of the same offense or defense motion by the player. The association is a link between controller generated trajectories, of a pre recorded play of a pair of pro players for offense and defense.
i) The 3D positional motions and time are used to arrive at velocities and accelerations of motions. A mass memory and mass memory addressing scheme (will be explained later), is used to read the predictions, plans and video of the motions of the image. It will include the early and continuation of the early perdition of the moves of a player as an offense or defense. This prediction involves the detection of continuation of the same motion of the player towards a goal. This prediction or expectation is in a form of upcoming image and player's trajectories (The associated memory addressing will be explained in later paragraphs).
   Each offense or defense, the “event” will be associated with a prediction and a plan. the prediction will predict that the player will continue with the same event for the rest of the intended motion. A plan is a controller generated image of a pro player that reacts and responds to the player's detected event.
j) For each game, the predictions and the plans will further be refined and categorized into degree of player's desired expertise and styles of play.
k) After the detection of an “event”, the player's motions are further received and analyzed to the end of the predicted motion.
l) The detection is continued unless a new event is detected due to player's discontinuation of initial movement and restart of a new event.
m) The memory addressing includes an electronic quantization (divide) circuit and a memory address lookup table is used to translate physical attributes of a player including its motion strengths to generate a memory bank address and an absolute address within a memory bank that is basis to write or read prediction/plan scenarios and corresponding image's video.
n) Using the capability provided in above steps, the player is provided the option to choose the degree of skill and different styles of a play (by choosing offense or defense from a menu of different players famous in that game).
o) Programmer assisted learning is accomplished during the detection and follow up of a player's real time motions compared to an existing predicted values in the memory bank. New entries in the memory banks are made either automatically or by the program.
by adjusting different variables that signifies different thresholds of motions, and utilizing methods in this application, the program is instructed to reduce the quantization levels, thus detect more refined levels of player motions during detection.
p) store new refined values in the predictions data banks for more accurate prediction process.
q) At the end of the prediction or plan, the trajectory of the player and the image's motion, are compared to evaluate scores and awarding points to each of the players for successful offensive and defensive actions.

### Hardware

The above method apparatus utilizes a digital video camera interfaced to a distributed controller to analyze motion of a player in real dynamic and interactive time.
a) Continually receive the camera's real time electro-optical, auto focus, and zooming controlled information along with video camera data for measuring the 3 dimensional positions of the player(s) at motions.
b) While in motion, the depth (z) is calculated by the ratio of the of the total pixel count of the colored elements worn by the player(s) to the total video pixels of the colored elements measured during initial calibration.
c) Utilizing a camera that could be commanded to perform auto focus or controller controlled (transmitted) focus commands.
d) Adjusting the pixel count information of the colored 3D geometric elements, and player(s) bodily signature based upon the received camera's auto-focus or controller controlled focus;
e) Trajectory of motion, speed, and acceleration of the players body parts is measured upon the differential changes of recent frame to the previous frame. provide filtering of images for a sharp image and elimination of background noises.
f) Differential changes are measured from frame to frame by following the periphery or calculated center of each colored element and measuring motion dynamics of velocity and acceleration.
g) Utilize a controller controlled camera that is commanded to focus and stay focus on a specific moving colored element.
h) Utilize a controller controlled camera that its zooming is controlled by a controller.
i) Utilizing the digital camera with inferred sensors to monitor the bodily temperature of the player.

### FIG. 5

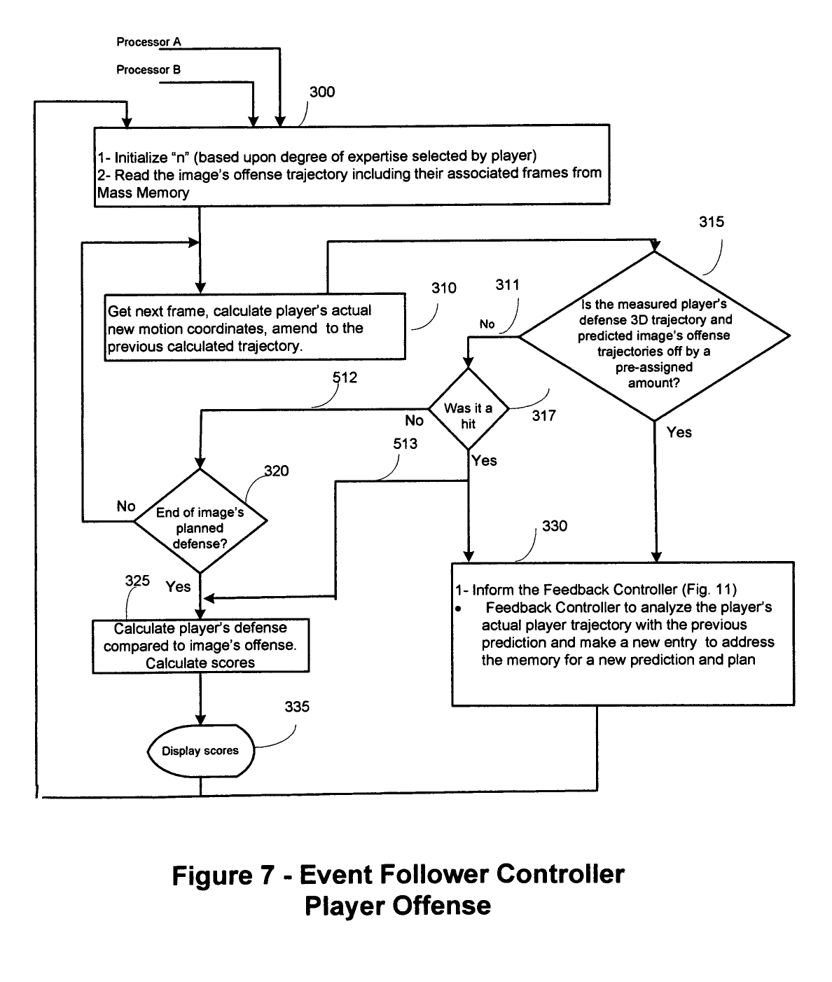

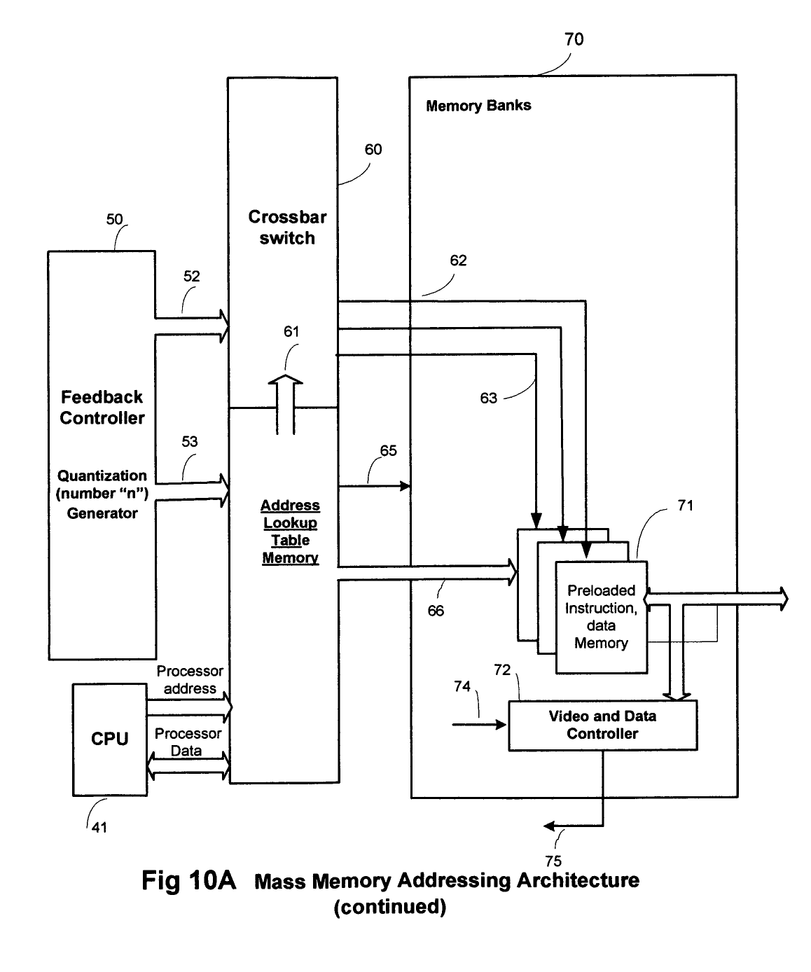

Referring now to Event Detector and Prediction Controller of FIG. 5. At block 100, all the initializations for the software to start properly takes place including receiving the player's physical attributes such as weight, height, degree of expertise and visible light and IR calibrations. At this time, the controller starts displaying of image's 3D activity. At block 105 the system checks for a start of offense or defense activity by the player for the controllers to mark the start (time) of an event. This means that the controller gets synchronized to the start of a player's offense or defense motions, or verbal commands on a frame by frame basis. Further steps are comprising of:
a) Each incoming frame is compared to the previous frame to detect a magnitude of change compared to the previous frame. Changes in the incoming frames surpassing a threshold are considered as a start mark in time of an event. If the detected motional activity such as distance, velocity and acceleration is detected, it transitions to block 115, that marks it as the start of an event, otherwise it goes to block 110.
b) At block 110, it increments “c”, incoming frames not surpassing a threshold for a certain period of time (“c” number of frames). This is to check the lack of activity of the player on frame by frame basis. It discards the inactivity data of the player during “c” time period. During the inactivity at each frame, it transitions to block 130 to check for the end of “c” number of frames, if “c” time has expired, it goes to block 140, that initializes “c” again and transitions to block 151, otherwise it goes block 100 to read the next frame.
c) At 100 voice activated command or other commands are analyzed and led to different processing stages, depending upon the nature of the commands;
d) at block 120, it checks for the continuation of same action that constituted an event at block 105, if the motions has not continued, it goes back to block 100 to initialize and start to look for an event again. If the event continues, it goes to block 125 to calculate distances, velocities, and accelerations and amend the information of the previous calculations.
   The trajectory of a motion, including location, velocity and acceleration are established each frame by setting addresses to the mass memory and reading the pre established information. In the following paragraph, the addressing schemes to the Mass Memory Banks, will be explained. The addressing scheme will be discussed in FIGS. 10 and 10A.
   Consecutive frames that have passed the threshold block 120, each are compared to the previous frame to detect the magnitude of change. changes are added to the previous trajectory of the player's motions.
e) At block 135, if the number of received frame is less than “b” (that corresponds certain elapsed time, depending upon frame rate), go back to block 115, otherwise go to block 143 to set address to the mass memory bank to read the predictions and plans, the transition to block 145.
f) At block 145 a decision is made to reveal the status of the player that is engaged in an offence or defense.
g) At block 145, if the player's motions indicate an offense aimed at the image's sensitive parts go to block 150. If it is defense, go to block 151. The offense or defense decision is made available to the Event Follower Offense or Defense Controllers FIGS. 6 and 7.

### FIG. 6

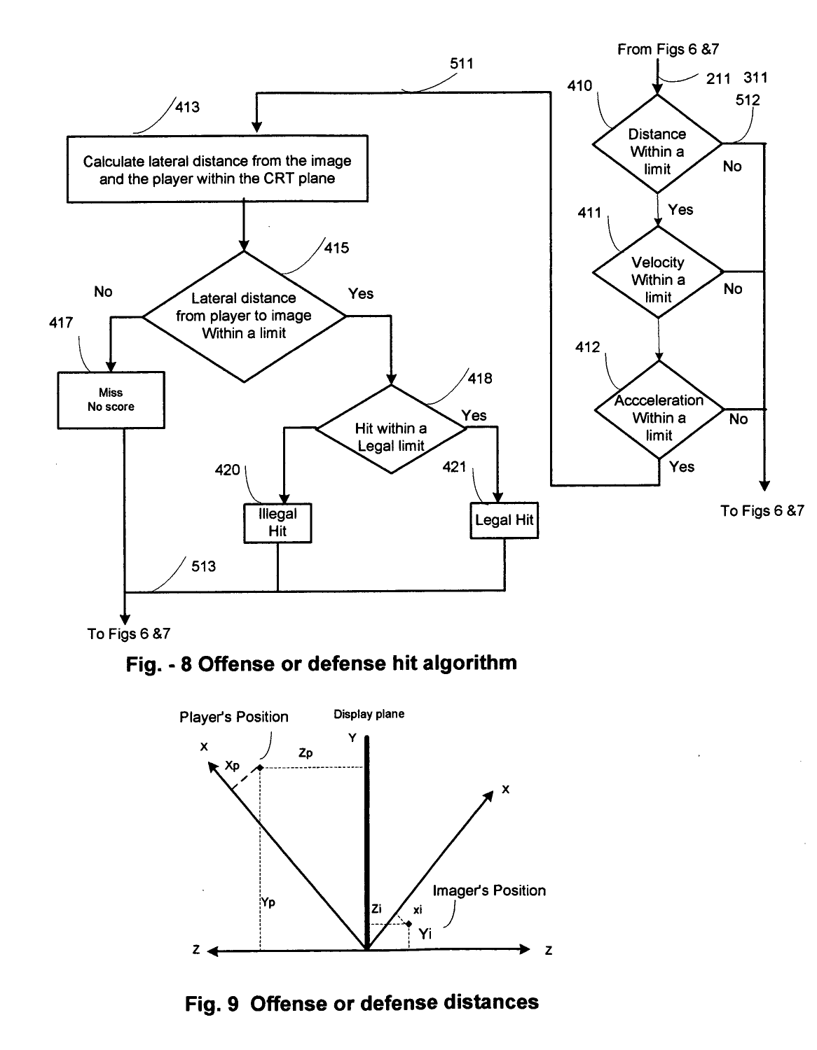

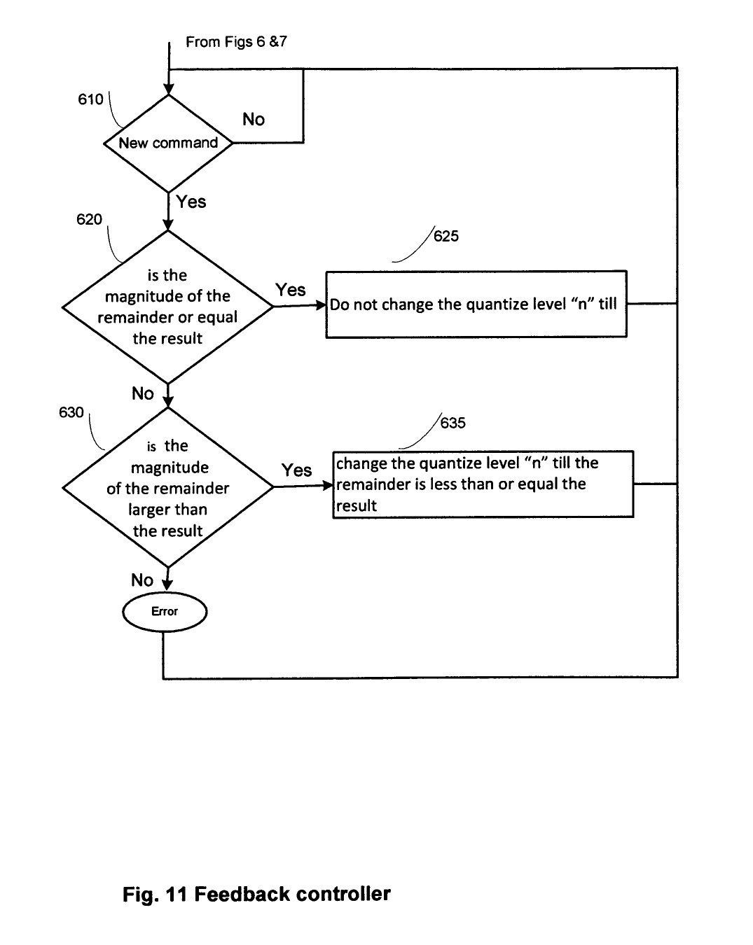

Referring now to the Event Follower Controller of FIG. 6, when it receives player's offensive event block 200, it will initialize quantization number “n” (based upon degree of expertise selected by the player), read the player's offense trajectory prediction and image's defense trajectory plan including their associated frames from Mass Memory to perform the following:
a) At block 210, get next frame, establish player's actual new motion coordinates, and amend to the previous trajectory. Continually display the planned offense motions of the image and transition to block 215.
b) At block 215, compare player's, prediction trajectory with the actual trajectory of the player. If the measured player's offense 3D trajectory and predicted player's offense trajectories off by a pre-assigned amount (this will be explained in the following paragraphs and it is related to the player' motion information divided by a number “n”) go to block 230, otherwise go to block 217.
Note:
The details of block 217 is shown in FIG. 8 that will be discussion in following paragraphs.
c) At block 217 it checks to see if the player's offense penetrates or hits the image's defense, (in otherwise a hit). If it does not go to block 220, otherwise go to block 230, and block 225.
d) Compare the real time positional trajectory of the player with image's positions trajectory. When the offensive (fist, or leg) body parts of the player's trajectory penetrates a positional boundary (a distance) of defensive body parts of image, a score is made. The score includes, the player and images velocity and acceleration at the time of the impact as is explained in FIG. 8.
e) At block 220, check for the image's planned defense. If it is not the end of planned defense, go to block 210, otherwise go to block 225.
f) block 225 calculate players offense compared to the image's defense, show scores, and go to block 200.
g) At block 230, inform the Feedback Controller for the Feedback Controller to analyze the player's actual trajectory with the previous prediction and make a new entry to address the memory for a new prediction and plan and transition to feedback controller (FIG. 11).

FIG. 7

Referring now to FIG. 7, Event Follower Controller, At block 300 initializes “n” (based upon the degree of expertise selected by the player), receives player's offensive event, it will read the player's predictive offense trajectory and image's defense trajectory plan including their associated frames from Mass Memory to perform the following:
a) At block 310, get next frame, calculate player's actual new motion coordinates, and amend it to the previous trajectory. Continually display the planned offense motions of the image and transition to block 315.
b) At block 315, compare player's, defense prediction trajectory with the actual trajectory of the player's defense. If the measured player's defense 3D trajectory and predicted player's defense trajectories off by a pre-assigned amount go to block 330, otherwise go to block 317.
Note:
The details of block 217 is shown in FIG. 8 that will be discussion in following paragraphs.
c) At block 317, it checks to see if the player's defense is penetrated by the image's defense (explained in FIG. 8). If it does not go to block 320, otherwise go to block 330, and block 325.
d) At block 320, check for the image's planned offense. If it is not the end of planned offense, go to block 310, otherwise go to block 325.
e) block 325 calculate players defense compared to the image's defense, show scores, and go to block 200.
f) At block 330, inform the Feedback Controller for the Feedback Controller to analyze the player's actual player trajectory with the previous prediction and provide a new quantization entry for “n” (explained in FIGS. 10 and 10A) to address the memory for a new prediction and plan.

### FIG. 8

Referring now to FIG. 8 (that is the detailed block diagram of blocks 217 and 317 in FIGS. 6 and 7), for the hit and scoring process. When the measured player's offense 3D trajectory and predicted image's offense trajectories are not off by a pre-assigned amount (block 215 of FIG. 6), the process enters block 413 of FIG. 8. Diagonal distance from the image and the player within the CRT plane are calculated. This done by updating player's distances, velocities, and acceleration registers of the memory bank addressing (as will be explained in FIG. 10). The Image's motion characteristics are updated in the feedback registers of memory bank addressing. The diagonal distance from player to image and the decision on the hit or no hit is provided by the memory bank data. If it is not a hit it is considered a miss (dodge) block 417, otherwise it is considered a hit and scores are made. The process then goes back to FIG. 6 block 225.

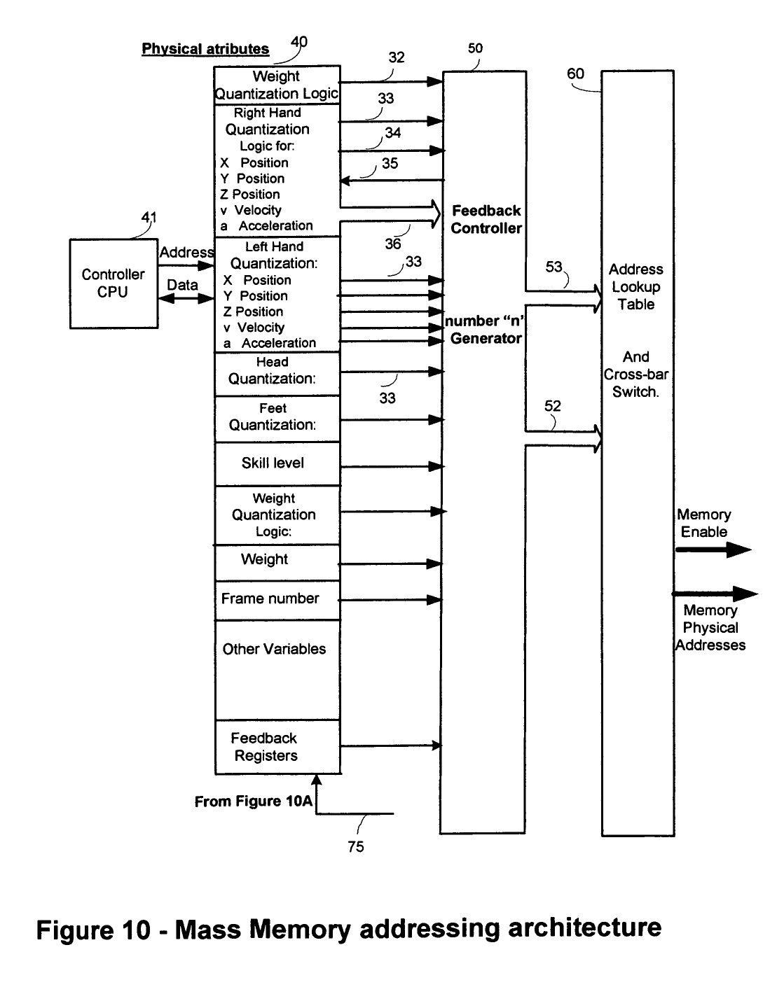

### FIG. 9

FIG. 9 is the representation of measured player distances and image's provided distances from the mass memory in which the mass memory provides the hit or not hit decision.

### FIG. 10

Referring now to FIG. 10, that is a hardware block diagram for addressing a Mass Memory. Its architecture is based upon 1) a controller to address group of logic dividers contained in an electronic module, with each divider logic interface with the controller to write to the divider's numerator physical and personal attributes of a player, such as weight, skill levels and motion characteristics such as 3D location, velocity, and accelerations of different parts of the players body movements. The divides are used as a quantization block that is used to 1) reduce memory addressing (hardware) lines. 2) Be used as a tool to provide assisted learning capability of the system. 3) It utilizes a Feedback Controller unit that receives the results and the remainder of the input magnitudes (numerator) from the divisors. The Feedback Controller uses the input data to generate or update a new quantization number “n”. 4) It also consists of a Address lookup table that translates the physical attributes of the player to a physical address of the memory including memory bank addressing. 5) A crossbar switch to enable individual memory units within the mass memory.

Initially, when the program is being developed, the mass memory will be used to store data from video of two player's, being engaged in a combat with one another and their motions captured by each one wearing a camera (and other cameras monitoring the play). Using the same apparatus, an appropriate quantize number “n” is chosen based upon the skill levels of the player before the game starts. This quantize number “n” is used as a devisor of the magnitudes of physical and motion data of the players such as weight, distance, velocities, and accelerations. When the Feedback Controller receives the result of the division and the remainder, it analyzes them to establish new “n”. The divisor “n” is adjusted until the remainder is less than the result.

When the play is in progress, the Feedback Controller checks the remainder and the magnitude of quantized data for one “n”. If the remainder is within the quantized magnitude, it does nothing. If the remainder is higher or lower than the quantized magnitude, it provides a list of umber of changes of “n” for each one of the result and remainder data entries, for the operator (programmer) to check the changes and generate new addresses to the mass memory (from one of the existing “not used” memory addresses lines). As a continuous development and learning process, the operator provides new prediction to the players trajectory, new plan of action including the trajectory and the video of the image and stores it in the relevant new address. This is very similar to a child being taught new skills.

Referring again to FIG. 10, the block diagram for mass memory addressing, block 40 are the registers that a controller will provide the physical and motion attributes of a player to these registers. The data from these registers are fed to the computation block (divisors), or directly to the address lookup table 60. The result of the division and the remainder are sent to Feedback Controller 50. The Feedback Controller also provides the divisor “n” for each data to the computation block. The computation block provides the division and sends the remainder and result of each set of data to the Feedback Controller. The Feedback Controller checks the remainder ageist the magnitude of the result and provides a list of all new quantization number (divisor) “n” for the operator to read and provide new predictions, plans and video in the mass memory. The programmer then develops these new capabilities and generates a new physical address to the memory, for future play.

These new quantization numbers are used by a programmer to provide new skills to be utilized and thus an assisted learning.

### FIG. 10A

Referring now to the block diagram of FIG. 10A that is the continuation of FIG. 10 for mass memory addressing. The Feedback Controller block 50 provides the proper quantization number “n” as partial address to the crossbar switch and address lookup table memory block 60. Signals 52 and 53 are the result of quantization addressing discussed earlier. The Crossbar switch gets its control signals from the address look up table signals 61, and enables individual memory units blocks 71 in the mass memory with signals 62, and 63. The Address Lookup Table is a memory in which partial addresses from the Feedback Controller point to a memory location in which the logical addresses are found. These are the address to individual memory units within the banks. The crossbar switch will also enable individual memory blocks within mass memory system.

### FIG. 11

Referring now to the block of FIG. 11 for the feedback controller to adjust the quantization number “n” to account for the degree of the player's desired expertise and enable assisted learning. Block 610 awaits for the a new command from the event detect controller and event follower controllers. It does the following:
a) if the magnitude of the remainder is equal or less than the result keep the existing quantize level “n”;
b) If the magnitude of the remainder is larger than result, change “n” till remainder is less or equal the result;
   report the new quantize level “n” to the arithmetic divider block;

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. An apparatus and a method of playing real time interactive motion related hand-to-hand combat involving a player wearing 3D glasses and 3D colored geometric shapes on his/her moving bodily parts such as head, hands and feet to get engaged with virtual image of a competitor player; the apparatus receiving the video frames of the player, initially checking for an offense or defense motion that takes place within a short time, in relation to the time that it takes for an effective single stroke of player's offense or defense, and reading a prediction for continuation (trajectory) of same offense or defense of the player along with a plan, for displaying an appropriate offense or defense video motions of the player; the apparatus compares the actual player motion to the prediction of the player; through an establishment of quantizing the player's body motions based upon the initial prediction and comparison to the actual trajectories of the play, thus an assisted learning is provided; the apparatus comprising the following summarized steps:
a) the apparatus captures the received video frames from the player and identifies portions of the player with individual 3D colored geometric shape elements thus identifying body parts of the player while in motion;
b) determining positions in 3-space of the portions of the player on each video frame, thus calculating changes in 3-D position from one frame to another frame;
c) the positional changes in a frames, in conjunction with the associated frame timing (period between frames) allows the derivation of velocity, acceleration from previous frame to the next;
d) the initial trajectory of a motion, during a short time at the beginning of each stroke, including location, velocity and acceleration are established for a typical player motion in a period of time ('b′ number of frames set during the initialization);
e) identifying each player's early moves that is consistent within the arbitrary period of time, “b” to represent an early offense, defense, or no motion, the early detections of each player motions that is identified as a beginning of the player motion such as a hit, a stroke, or a dodge are hereafter called an “event”;
f) each event is further associated with a continuation of the same offense or defense motion by the player, the association is a link between a controller generated trajectories, of a pre recorded play of a pair of pro players for offense and defense;
g) using the information derived from the above, recognizing the early moves of a player as an offense or defense and predict a continuation of the same motion of the player towards a goal; this prediction or expectation is in a form of upcoming player's trajectory hereafter called a “prediction”;
h) each offense or defense event will be associated with a prediction and a plan, the prediction will predict that the player will continue with the same event for the rest of the intended motion; a plan is a controller generated video image of a pro player that reacts and responds to the player's detected initial event;
i) for each game, the predictions and the plans will rely on a system of dividing player specifications and measurement motions magnitudes as a numerator divided by a quantization number “n” used as a divisor; comparing result of the division with the remainder, for the game be further refined and categorized into different quantization levels that is used for the process of further modifications and degrees of player's desired expertise and styles of play;
j) after the detection of an event, the player's motions are further received and analyzed to the end of the predicted motion;
k) the detection and the plan is continued unless a new event is detected due to player's discontinuation of initial movement and restart of a new event;
l) the electronic quantization (divide) circuit and a memory address lookup table is used to translate physical attributes of a player including its motion strengths to generate new memory bank addresses within a memory bank to write and read prediction trajectories and plan scenarios;
m) programmer assisted learning is accomplished during and follow up of a player's real time motions through quantization method and compared to an existing predicted trajectories that is stored in the memory banks, thus new entries in the memory banks are created by the programmers;
n) by adjusting different variables that signifies different thresholds of motions, and utilizing methods in this application, the program is instructed to change the quantization numbers, thus detect more refined levels of player motions during detection, for assisted learning purposes;
o) store new refined values in the predictions data banks for more accurate prediction process;
p) at the end of the prediction or plan, the trajectory of the player and the image's motion, are compared to evaluate scores and awarding points to each of the players for successful offensive and defensive actions;
q) using the capability provided in above steps, the player is provided the option to choose the degree of skill and different styles of a play (by choosing offense or defense from a menu of different players famous in that game).

2. The method of claim 1 wherein, utilizing a digital video camera interfaced to a distributed controller to capture real time 3-D motions of a player comprising the further steps of:
a) calibrating the system initially by placing the player(s) at a fixed distance from the camera and having the colored elements, and bodily signatures of the player to be calibrated with a video gray scale for real time 3-D motion detection;
b) continually receiving the camera's real time electro-optical, auto focus, and zooming control information along with video camera signals measuring the 3 dimensional positions of the player(s) at motions;
c) while in motion, the depth (z) is calculated by the ratio of the of the total pixel count of the colored elements worn by the player(s) to the total video pixels of the colored elements measured during initial calibration;
d) utilizing a camera that could be commanded to perform auto focus or controller controlled focus;
e) adjusting the pixel count information of the multi colored geometric elements, and player(s) bodily signature based upon the received camera's auto-focus or controller controlled focus;
f) trajectory of motion, speed, and acceleration of the players body parts is measured upon the differential changes of recent frame to the previous frame, provide filtering of images to provide a sharp image and eliminate background noises;
g) differential changes are measured from frame to frame by following the periphery of each colored element and measuring pixel changes;
h) utilize a controller controlled camera that is commanded to focus and stay focus on a specific moving colored element;
i) utilize a controller controlled camera that its zooming is controller controlled;
j) placing the digital camera on a controller controlled gimbal to follow the player's motions. the pixel count derived from step c will be further adjusted based upon the 2-d gimbal motions;
k) utilizing the digital camera with inferred sensors to monitor the bodily temperature of the player.

3. Provisions of claim 1 for addressing a Mass Memory, wherein physical attributes of a player and detected motion are used to generate the Memory Bank address; the physical attributes are input to a plurality of logic dividers within a module to quantize the data; a Feedback Controller receiving the quantized information to check and decide if the quantized level “n” (result of the divisor) need to be changed; an address lookup table to translate quantized physical data to a physical memory address; a crossbar switches to enable reading relevant data module in the Mass Memory, and a video data output controller looking at the Mass Memory; a video and data controller, interfaced to the output of the Mass Memory to distribute data to various registers including Feedback Registers; as follows:
a) a mathematical block consisting of plurality of logic dividers each having a input holding register; each register is set to different variable values of a(1), a(2), a(3), to a(x), wherein “a” denotes the input variables data of player's body parts including personal specification such as weight, height, degree of expertise, and measured motional variables including distances, velocity and accelerations that are used as the numerators to the dividers;
registers, receiving its data from different sources, of sensors or computations or feedbacks from the mass memory;
mathematical calculators coupled to each one of the “n” register to perform mathematical operation on the content of the registers;
divider circuits divides personal specifications and motional variables of a player used a numerator divides them by an integer “n”, provided during initialization and dynamically changed during a play;
each physical motion variable will have its own quantization number “n”;
the integer results and the remainder are sent to the Feedback Controller to decide on the next level of divisor “n” for assisted learning purposes;
to quantize physical attributes of a player such as physical specifications (weight and others) and derived motion activities of players body parts such as location, velocity and acceleration;
b) the Feedback Controller receiving divisor, results and the remainder, examines the result and the remainder to performs the following:
if the magnitude of the remainder fall within the result keep the existing quantize level “n”;
if the magnitude of the remainder is larger than result, change “n” till remainder is less or equal the result;
report the new quantize level “n” to the arithmetic divider block;
c) an Address Lookup Table memory or a cascaded address lookup table receives plurality of quantized variable data for each one of the player's physical and motion attributes from the feedback controller;
the data of the address look up table is preloaded by the controller to translates the physical attributes of the player, to a the physical logical address of the mass memory;
part of the output address from the feedback controller is set as an input address to a Crossbar Switch to provide enabling of memory modules and memory units within the mass memory;
the feedback controller to set crossbar switch controls for connection of one of the inputs to output of the crossbar switch;
d) a data controller interfaced to the mass memory output to transfer video data to the video terminals, read prediction and plan trajectories and read the feedback information; feedback information are stored in registers to be used as another address to the feedback controller;
e) the feedback address could get bypassed by a signal from controller feedback controller;
f) Mass Memory data includes a pre established predictions of a player based upon initial detection of an event, predictions of the image player, plans for future actions of the image and 3D video data pertaining to the image's motion trajectories, and its corresponding 3D offense or defense motion;
initially, when the program is being developed, the mass memory will be used to store data from video of two player's, being engaged in a combat with one another and their motions captured by each one wearing a camera (and other cameras monitoring the play); using the same apparatus, an appropriate number “n” is chosen as a devisor of the magnitudes of physical and motion data of the players such weight, distance, velocities, and accelerations; the divisor “n” is adjusted by the Feedback Controller such that the remainder is less than the magnitude of the result;
when the play is in progress, the Feedback Controller checks the remainder and the magnitude of the result; if the remainder is equal or within the result magnitude, it does nothing; if the remainder is higher or lower than the quantized magnitude, it provides a list of umber of changes of “n” for each one of the data entries, such as distance velocity and accelerations for the operator (programmer) to check the changes and generate new addresses to the mass memory (from one of the existing “not used” memory addresses); the operator will then provide new prediction to the players trajectory, new plan of action including the trajectory and the video of the image and stores it in the relevant new address; this is very similar to a child being taught new skills.

4. The method of claim 1 wherein the controller's further actions are synchronized to the start of a player's motions, or verbal commands on a frame by frame basis, further comprising the steps of:
a) each incoming frame is compared to the previous frame to detect the magnitude of change compared to the previous frame. changes in the incoming frames surpassing a threshold are lead to further processing, changes in the incoming frames not surpassing the threshold are counted, discarded, and led to further processing;
b) continuous incoming frames not surpassing a threshold for a certain period of time (“c” number of frames) are counted, discarded, and led to an offense motion by the controller generated image;
c) the trajectory of a motion, including location, velocity and acceleration are established for a player motion in real time;
d) generate an imaginary x, y, and z positional distances of player with respect to the CRT position as a reference; generate an imaginary x, y, and z positional distances of image with respect to the CRT position as a reference; a diagonal distance is generated from two points of the image and the player's positions offense and defense parts hereafter called “penetration distance”; when the penetration distance is reached by the designated offense and defense parts, a score is made;
e) the voice activated command or other commands are analyzed and led to different processing stages, depending upon the nature of the commands;

5. The apparatus of claims 1, 2, 3 and 4 wherein an Event Detection and Prediction distributed digital image controller, continually monitors the offense and defense movement of the player to detect offense and defense motions that are consistent within certain time period (“b” number of frames) called an event and is defined as offense or a defense motion by the player; comprising of the steps:
a) consecutive frames that have passed the threshold, each are compared to the previous frame to detect the magnitude of change, changes are added to the previous trajectory of the player's motions;
b) if received frame number is less than b number of frames, repeat previous step, otherwise go to the next step;
c) set address to the mass memory and check (at the end of “b” number of frames), the results of the player's motions with that of the image at the end of “b” number for frames;
the Mass memory is used for comparison of trajectories the player and the image during each frame by setting the trajectory of the image to the feedback registers and reading the result from the pre loaded memory data for each body parts;
d) if at the end of “b” number of frames, the player's motions indicate an offense aimed at the image's defensive trajectory, continue processing player's offensive by informing an Offense Event Follower Controller otherwise inform the an Event Defense Controller.

6. The apparatus of claims 1 wherein the Offense Event Follower Controller receives player's offensive event from the Event Controller, it performs the following steps:
a) read the image's defense trajectory plan from Mass Memory and initialize “n” that is dependent upon degree of expertise initially chosen by the player;
b) from the next incoming video frame, calculate player's actual new motion coordinates, amend it to the previous calculated trajectory; continually display the planned offense motions video of the image and transition to next step;
c) compare image's prediction trajectory with player's actual trajectory of motion; if the measured player's offense 3D trajectory and predicted image's defense trajectories are off (based upon the value of “n” as explained in claim 5, go to step g), otherwise go to next step;
d) checks if the player's offense penetrates or hits the image's defense; if it does not go to step e), otherwise go to step f);
players motion characteristics are updated in mass memory input registers and image's motion characteristics are updated in the feedback registers of memory bank addressing; the distance from player to image and the decision on the hit or no hit is provided by the memory bank data; if it is not a hit is considered a miss (dodge) otherwise it is considered a hit and scores are made; the process then goes to next step;
e) check for the end of image's planned defense; if it is not the end of planned defense, go to step b), otherwise go next step;
f) calculate players offense compared to the image's defense, show scores, and go to step a);
g) inform the Feedback Controller for it to analyze the player's actual player trajectory with the previous prediction and make a new entry “n” as a new address to the memory and a new levels of prediction and plan.

7. The apparatus of claims 1 wherein the Defense Event Follower Controller receives player's defensive event from the Event Controller, it performs the following steps:
a) read the image's offense trajectory plan from Mass Memory and initialize “n” that is dependent upon degree of expertise initially chosen by the player;
b) from the next incoming video, frame, calculate player's actual new motion coordinates, amend it to the previous calculated trajectory; continually display the planned offense motions video of the image and transition to next step;
c) compare image's prediction trajectory with player's actual trajectory of motion; if the measured player's offense 3D trajectory and predicted image's offense trajectories are off (based upon the value of “n” as explained in claim 5, go to step g), otherwise go to next step;
d) checks if the player's offense penetrates or hits the image's defense; if it does not go to step e), otherwise go to step f);
players motion characteristics are updated in mass memory input registers and image's motion characteristics are updated in the feedback registers of memory bank addressing; the distance from player to image and the decision on the hit or no hit is provided by the memory bank data; if it is not a hit is considered a miss (dodge) otherwise it is considered a hit and scores are made; the process then goes to next step;
e) check for the end of image's planned offense; If it is not the end of planned offense, go to step b), otherwise go to next step;
f) calculate players offense compared to the image's defense, show scores, and go to step a);
g) inform the Feedback Controller for it to analyze the player's actual player trajectory with the previous prediction and make a new entry “n” as a new address to the memory and a new levels of prediction and plan.

8. A method claim 1 for playing a motion related hand-to-hand combat type game, between a player and the image of a competitor player; each player is provided with its own sets of cameras and the said apparatus that detects and calculates both players' motions; the method comprising the steps of:
a) identifying portions of the players with individual colored elements and thus identifying player's initial calibration measurements;
b) recording the players as video images and filtering the images into separate signals according to the colored elements for both of the players;
c) calculating rotational changes of colored elements;
d) all the offense and defense bodily parts (colored elements) are initially calibrated with respect to the distance to the camera;
e) transmit the positional calibration measurements of the player 1 to player 2 controller;
f) determining real time positions in 3-space of the portions of the players on each video frame of each of the recordings of the relevant player, and calculating changes in position between each of the frames, and further generating 3D trajectory of relevant player including x, y, z, velocity, and acceleration of each of the portions movements;
g) the real time video or real time trajectory changes of the player 1 is transmitted to the player 2 controller;
h) continually transmitting the player's video or changes in the motion trajectory of the player 1 to the player 2;
i) each controller will generate an imaginary x, y, and z positional boundaries of their respective player. The imaginary boundary creates a circular boundary around each player's real time positions in all three dimensions that is updated on frame by frame basis;
j) the boundary for each player's bodily part is a variable number that its value is based upon each body part and that is adjusted to signify degree of player's skill
k) the received video or the trajectory of player 2 is subtracted (or normalized) from the initially received calibration of player 2;
l) the real time trajectory and circular boundaries of the player 1 is compared to the normalized trajectories player 2;
m) when the sensitive (head or belly, or others) body parts of the player 1 trajectory boundaries are penetrated with the normalized offensive body parts of the player 2, a score is made;
n) velocity, and acceleration of the player 2's offensive part penetrating the positional circular boundaries of player 1 is the degree of score.

9. A method of claim 1, claim 4, and claim 5 wherein assisted learning is accomplished during the detection and follow up of a player's real time motions when compared to the predicted value; if the real time detected trajectories are deviant from the projected by a pre assigned positive or negative value, the player motions are captured and stored for later analysis and additions to the predictions memory bank by methods comprising the steps of
a) a camera is attached to a pair of players, each camera capturing the opponent's real time motions; the trajectory of the motions later analyzed for initial baseline programming of the offense and defense predictions memory data;
b) conventional video data generation is utilized for the initial and baseline programming of the offense and defense predictions memory data;
c) the deviations from the baseline are captured for later analysis of offense and defense predictions and setting up different thresholds of motions needed for detection and assisted learning;
d) based upon the initial baseline memory prediction bank and the said apparatus, the captured motions of a pro players is fed to this program to learn and store a more refined levels of real time player motions for prediction purposes;
e) captured motions that are deviated from the baseline are further analyzed by the programmers for a realistic additions to the initial memory prediction process;
f) the program can be set to a assisted learning mode by allowing it to select a higher levels of quantization of the captured real time motions variables, and thresholds outlined in above claims 1, for more refined additions and entries to the memory bank;
g) the degree for player's speed, is decided by adjustment of “b” number of frames (claim 4) for player speed selection;
h) degree of expertise is chosen by selecting lower or higher quantization levels of prediction memory bank.

10. The method of claim 1 further comprising the step of increasing the number of cameras and display monitors to assist the player's view of the image at different angles while turning and facing from one camera to another, wherein:
a) the Controller to provide an image 3d field of play for the player to use as a visual guidelines for his/hers movements in a field of play, while the image is moved around from one side of the field of play to the other;
the Controller to detect player positions from different cameras and decide which camera provides the best detection angle and display the image in a relevant field of play to be viewed by the player.
